(19) United States
(12) Patent Application Publication
(10) Pub. No.: US 2014/0023243 A1
(43) Pub. Date: Jan. 23, 2014

(54) KERNEL COUNTER

(71) Applicant: Dow Agrosciences LLC, Indianapolis, IN (US)

(72) Inventors: Nandi Nagaraj, Indianapolis, IN (US); Reetal Pai, Carmel, IN (US); Pradeep Setlur, Carmel, IN (US); Terry R. Wright, Carmel, IN (US)

(73) Assignee: Dow Agrosciences LLC, Indianapolis, IN (US)

(21) Appl. No.: 13/947,137

(22) Filed: Jul. 22, 2013

Related U.S. Application Data
(60) Provisional application No. 61/674,602, filed on Jul. 23, 2012.

(51) Int. Cl. G06K 9/00

(52) U.S. Cl. CPC G06K 9/00624
USPC 382/110

(57) ABSTRACT

An apparatus and method for determining the number of kernels on a sample cob are provided. In one embodiment, an image including a front region of the sample cob, and a back region of the sample cob displayed in at least one reflective surface are provided to an image processor that identifies the presence of kernels in the image and determines the number of kernels based on the identified presence of kernels in the image.

### RELATED APPLICATIONS

This application claims the benefit of U.S. Provisional Application Ser. No. 61/674,602, filed Jul. 23, 2012, titled KERNEL COUNTER, docket DAS-P0259-01-US, the disclosure of which is expressly incorporated by reference herein.

### FIELD

The present invention relates to methods and apparatus for analyzing and evaluating plant samples and in particular to methods for analyzing and evaluating maize kernels on the cob.

### BACKGROUND

Determining the number of kernels per ear of maize is useful in estimating yield. Pre-harvest yield prediction methods, such as the yield component method, estimate yield from estimates of components that comprise grain yield, including the number of ears per acre, the number of kernels per ear (which may be comprise number of rows per ear and number of kernels per row), and the weight per kernel.

In one exemplary method of counting kernels, the number of kernels on a sample ear of maize is manually counted. In another exemplary method, kernels from one or more sample ears are separated from the cob before being manually or mechanically counted. These methods may be laborious and time consuming.

In another method, such as that described in U.S. Pat. No. 8,073,235 to Hausmann, et al., the number of kernels per ear is estimated based on the number of kernels visible from a single side of the ear. In this method, the number of kernels in an image of one side the ear is counted, and the total number of kernels per ear is estimated based on an empirical correlation between the number of kernels visible in an image and the number of kernels on an ear. Because the estimate relies on an image of a single side of the ear, the resulting estimate assumes little variation between rows on the ear, including little variation between rows of a tip area around the circumference of the cob.

### SUMMARY

In an exemplary embodiment of the present disclosure, an apparatus for determining the number of kernels on a sample cob is provided. The apparatus includes at least one reflective surface, an imaging system positioned to capture an image of the sample cob, the image including a front region of the cob and a back region displayed in the at least one reflective surface, and an image processor that receives the image from the imaging system, identifies the presence of kernels in the image, and determines the number of kernels based on the identified presence of kernels in the image of the sample cob.

In another exemplary embodiment of the present disclosure, a method for determining the number of kernels on a sample cob having a circumference is provided. The method includes positioning the sample cob between an imaging system and at least one reflective surface, the sample cob having a front region oriented towards the imaging system and a back region oriented away from the imaging system; capturing an image of the sample cob, the image including greater than 180° of the circumference of the cob; identifying a presence of kernels in the image of the sample cob; and calculating the number of kernels on the sample cob based on the identified presence of kernels in the image of the sample cob. In another embodiment, the determining step is further based on an identified presence of an exposed area of the sample cob.

The above mentioned and other features of the invention, and the manner of attaining them, will become more apparent and the invention itself will be better understood by reference to the following description of embodiments of the invention taken in conjunction with the accompanying drawings.

### BRIEF DESCRIPTION OF THE DRAWINGS

FIG. 1 illustrates an exemplary imaging system according to the present disclosure;

FIGS. 2A and 2B illustrate exemplary circumferences of a sample to be imaged;

FIGS. 3 and 3A illustrate exemplary photographic images produced by the imaging system of FIG. 1;

FIG. 4 illustrates another exemplary imaging system according to the present disclosure;

FIG. 5 illustrates an exemplary image processor;

FIGS. 6 and 6A illustrate digital images of the photographic image of FIG. 3; and

FIG. 7 illustrates an exemplary sequence for the image processor of FIG. 5.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to the analysis of kernels on a ear of maize, it should be understood that the features disclosed herein may have application to the analysis of other samples.

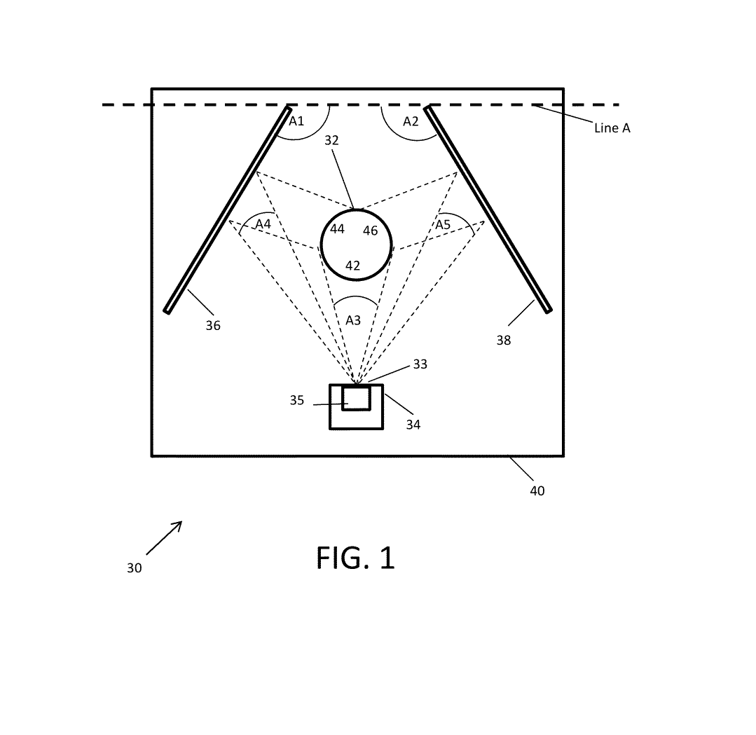

Referring first to FIG. 1, an exemplary imaging system 30 is provided. A sample 32 to be imaged is shown positioned in imaging system 30. In the illustrated embodiment, sample 32 is generally cylindrical and includes a circumference. Other suitable shapes having a circumference or a perimeter may also be used. An exemplary sample is an ear of maize, although other suitable samples may also be used.

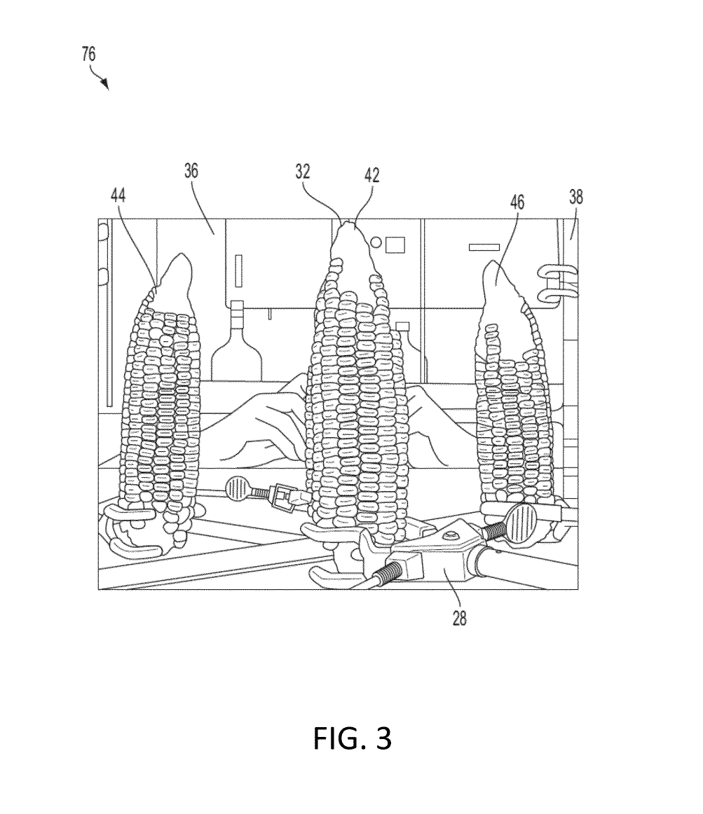

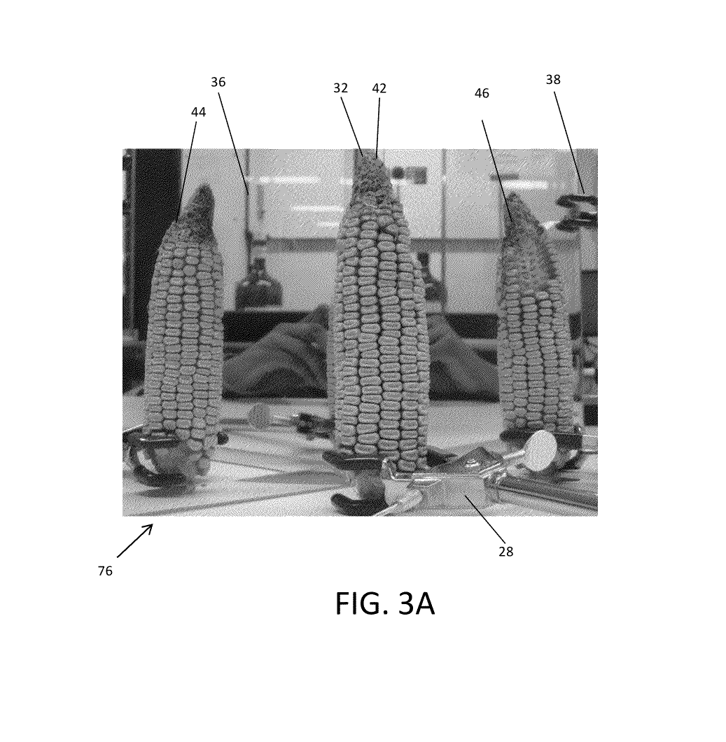

In one exemplary embodiment, imaging system 30 includes an image capture device 34. Image capture device 34 is a device capable of capturing an image. Exemplary image capture devices include cameras, CCD cameras, and other suitable image capture devices. Illustrated image capture device 34 includes aperture 33. In the illustrated embodiment, image capture device 34 captures an image 76 (see FIG. 3) through aperture 33 that includes showing a front region 42 of sample 32, a first back region 44 of sample 32 reflected in first reflective surface 36, and a second back region 46 of sample 32 reflected in second reflective surface 38, as shown by the arrows in FIG. 1. In one embodiment, the captured image includes greater than 180° of the circumference of sample 32. In one embodiment, the captured image includes greater than 360° of the circumference of sample 32. In one embodiment, the captured images includes from 180° to 360° or more of the circumference of sample 32. In another embodiment, the captured image includes greater than 180° of the perimeter of a non-cylindrical sample.

In the illustrated embodiment, a light source 35 is also provided. In one embodiment, light source 35 is provided as a part of image capture device 34. In another embodiment, light source 35 is independent of image capture device 34. Although illustrated as attached to image capture device 34, light source 35 may be positioned apart from image capture device 34. In still another embodiment, imaging system 30 does not include a light source, but may use light provided from the environment.

Imaging system 30 also includes first reflective surface 36, and second reflective surface 38. Exemplary reflective surfaces include mirrors and other suitable reflective surfaces. Line A indicates a line perpendicular to a line extending perpendicular to an image plane of the image capture device 34. First reflective surface 36 intersects line A at an angle A1. Second reflective surface 38 intersects line A at an angle A2. In one embodiment, A1 is equal to A2. In another embodiment, A1 is a different angle than A2. In still another embodiment, A1 and A2 are about 120°. In yet still another embodiment, first reflective surface 36 and second reflective surface 38 are positioned about sample 32 such that image capture device 34 is provided a reflected view of first back region 44 in first reflective surface 36 and a view of second back region 46 in second reflective surface 38.

In the illustrated embodiment, imaging system 30 is at least partially enclosed in container 40. In an exemplary embodiment, container 40 reduces or eliminates stray light for image capture device 34. In another exemplary embodiment, container 40 reduces or eliminates wind or particulates from interfering with imaging system 30. In another embodiment, imaging system 30 does not include a container 40.

In the embodiment illustrated in FIG. 1, the field of view of image capture device 34 displaying a direct image a front region 42 of sample 32 is labeled A3. The field of view of image capture device 34 displaying a reflected view of first back region 44 in first reflective surface 36 is labeled A4. The field of view of image capture device 34 displaying a reflected view of second back region 46 in second reflective surface 38 is labeled A5. The fields of view shown in FIG. 1 are only exemplary, and the relative size and position of A3, A4, and A5 depends on factors including the distance between sample 32 and the components of imaging system 30 and the angles A1 and A2.

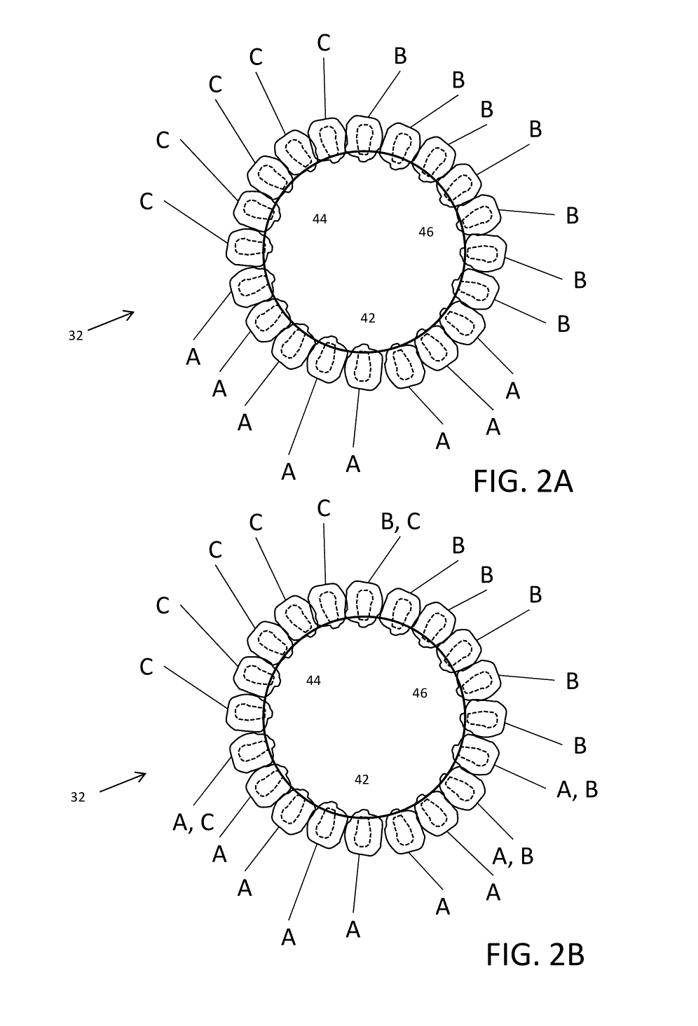

Referring next to FIGS. 2A and 2B, exemplary samples 32 are illustrated. Each sample 32 includes kernels labeled A, B, and C around at least a portion of the circumference of sample 32. Each sample 32 also includes a front region 42, first back region 44, and second back region 46. Image 76 (FIG. 3) includes an image of kernels A of the front region 42, an image of kernels B of the first back region 44 reflected in the first reflective surface 36, and an image of kernels C of the second back region 46 reflected in the second reflective surface 38. In the embodiment illustrated in FIG. 2A, image 76 includes only a single image of each kernels A, B, C. In the embodiment illustrated in FIG. 2B, image 76 includes multiple images of some kernels. In this embodiment, the kernel labeled A, B appears in front region 42 and second back region 46, the kernel labeled A, C appears in front region 42 and first back region 44, and the kernel labeled B, C appears in first back region 44 and second back region 46.

In one embodiment, at least a portion of the front region 42, first back region 44 reflected in first reflective surface 36, and second back region 46 reflected in second reflective surface 38 show overlapping portions of sample 32. In another embodiment, not all of sample 32 is visible in front region 42, first back region 44 reflected in first reflective surface 36, and second back region 46 reflected in second reflective surface 38.

Referring next to FIGS. 3 and 3A, an exemplary image 76 from the imaging system 30 of FIG. 1 is illustrated. The illustrated image 76 includes an image of the front region 42, an image of first back region 44 reflected in first reflective surface 36, and an image of second back region 46 reflected in second reflective surface 38.

In one exemplary embodiment, sample 32 is attached to sample holder 28. In the illustrated embodiment, sample holder 28 positions sample 32 such that the longitudinal axis of sample 32 is oriented substantially vertically. In another embodiment, sample holder 28 positions sample 32 in a substantially horizontal orientation. Other suitable orientations may also be used. In the illustrated embodiment, sample holder 28 positions sample 32 by gripping an external surface of sample 32. In another exemplary embodiment, a portion of sample holder 28 is inserted into a portion of sample 32 to position sample 32. In still another exemplary embodiment, sample 32 is an ear of maize and a portion of sample holder 28 is inserted into the cob of the ear of maize to position the ear.

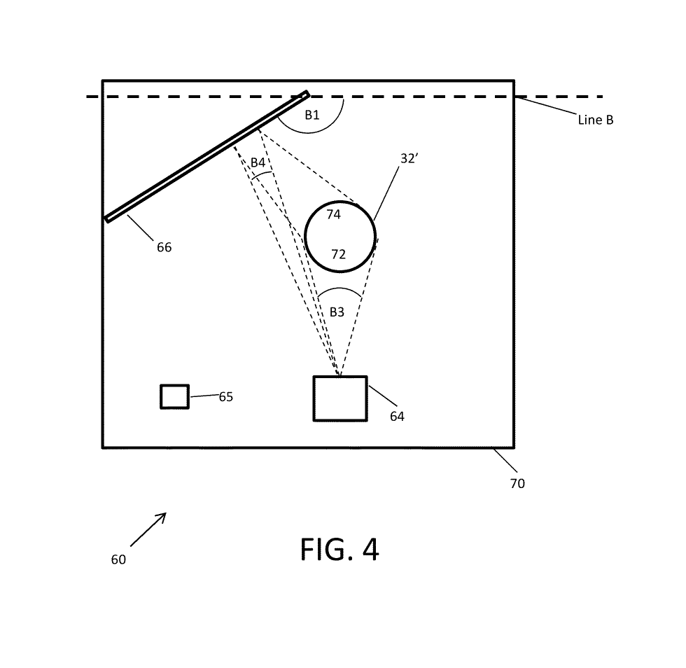

Referring next to FIG. 4, another exemplary imaging system 60 is provided. Imaging system 60 is similar to imaging system 30, but only a single reflective surface 66 is provided.

A sample 32′ to be imaged is shown positioned in imaging system 60. In one exemplary embodiment, imaging system 60 includes an image capture device 64. In the illustrated embodiment, a light source 65 and container 70 are also provided. Imaging system 60 also includes reflective surface 66. Line B indicates a line perpendicular to a line extending perpendicular to an image plane of the image capture device 64. Reflective surface 66 intersects line B at an angle B1. In one embodiment, B1 is from about 120° to about 180°. In another embodiment, B1 is from about 90° to about 120°. In still another embodiment, reflective surface 66 is positioned about sample 32′ such that image capture device is provided a reflected view of back region 74 in reflective surface 66.

In one embodiment, at least a portion of the front region 72 and back region 74 reflected in reflective surface 66 show overlapping portions of sample 32′. In another embodiment, not all of sample 32′ is visible in front region 72 and back region 74 reflected in reflective surface 66. In still another embodiment, front region 72 and back region 74 comprise more than 180° of the circumference of sample 32′.

Referring to FIG. 4, the field of view of image capture device 64 displaying a direct image a front region 72 of sample 32′ is labeled B3. The field of view of image capture device 64 displaying a reflected view of back region 74 in reflective surface 66 is labeled B4. The fields of view shown in FIG. 4 are only exemplary, and the relative size and position of B3 and B4 depends on factors including the distance between sample 32′ and the components of imaging system 60 and the angle B1.

Although exemplary systems with one reflective surface such as imaging system 60, and two reflective surfaces such as imaging system 30, are illustrated greater numbers of reflective surfaces may also be used. In addition, additional optical elements including lenses, fiber optics, reflective elements with optical power, and other suitable devices for forming an image or the sample 32 may be included.

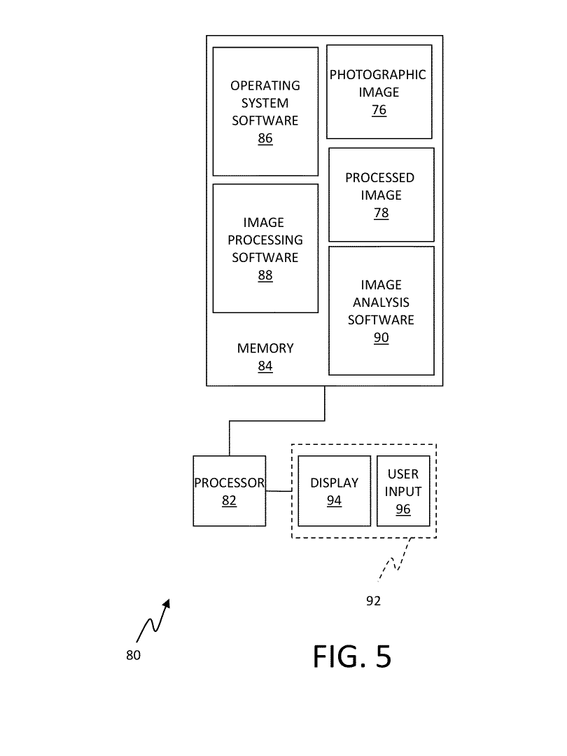

FIG. 5 illustrates an exemplary image processor 80 for analyzing image 76. Image processor 80 includes a processor 82 and memory 84. Processor 82 may comprise a single processor or may include multiple processors, located either locally with image processor 80 or accessible across a network. Memory 84 is a computer readable medium and may be a single storage device or may include multiple storage devices, located either locally with image processor 80 or accessible across a network. Computer-readable media may be any available media that may be accessed by processor 82 and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed by image processor 80. In one embodiment, image processor 80 communicates data, status information, or a combination thereof to a remote device for analysis.

In another embodiment, memory may further include operating system software 86, such as LINUX operating system or WINDOWS operating system available from Microsoft Corporation of Redmond Washington. Memory further includes communications software if computer system has access to a network, such as a local area network, a public switched network, a CAN network, and any type of wired or wireless network. Any exemplary public switched network is the Internet. Exemplary communications software includes e-mail software, internet browser software. Other suitable software which permit image processor 80 to communicate with other devices across a network may be used.

In another exemplary embodiment, image processor 80 further includes a user interface 92 having one or more I/O modules which provide an interface between an operator and image processor 80. Exemplary I/O modules include user input 96 and display 94. Exemplary user input 96 include buttons, switches, keys, a touch display, a keyboard, a mouse, and other suitable devices for providing information to image processor 80. Exemplary display 94 are output devices including lights, a display (such as a touch screen), printer, speaker, visual devices, audio devices, tactile devices, and other suitable devices for presenting information to an operator.

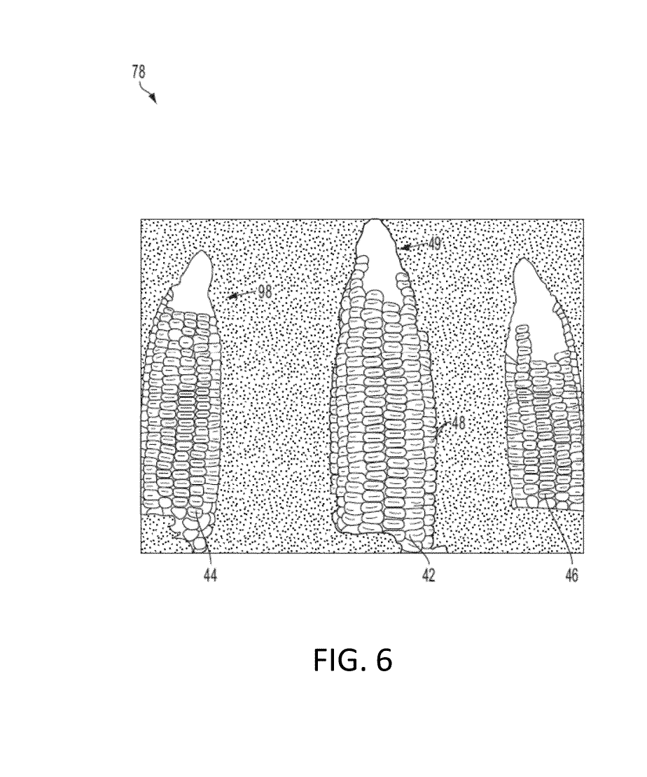

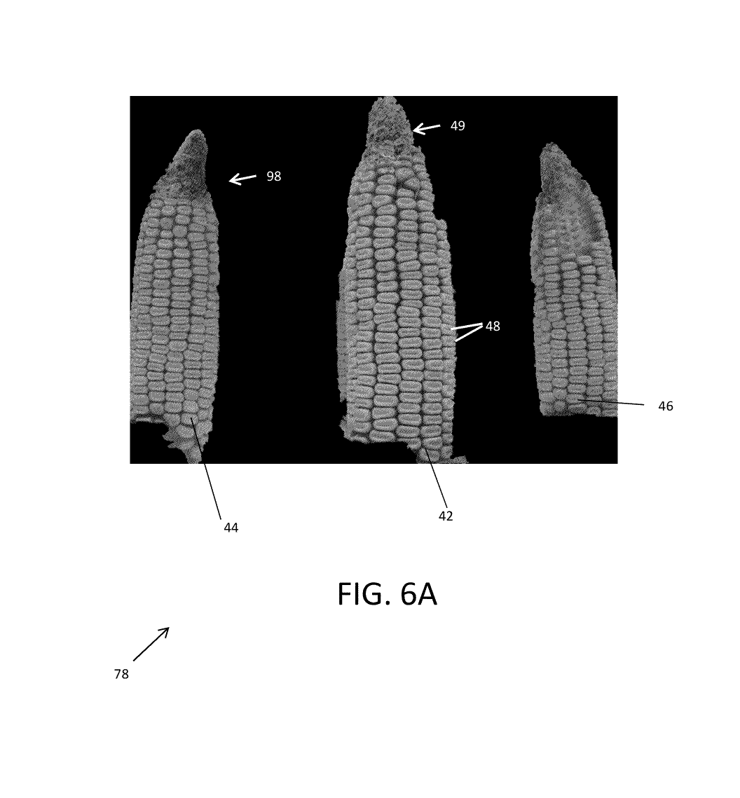

In one exemplary embodiment, image 76 is provided to image processor 80 and stored in memory 84. In the embodiment illustrated in FIG. 5, memory 84 includes image processing software 88, such as PaintShop Pro available from Corel Corporation, Ottawa, Ontario, Canada. Image processing software 88 may be used to processing image 76 to make kernels (such as kernels 48 in FIG. 6) easier to detect or count. In one embodiment, image processing software 88 may include image processing software routines for applying color filters to image 76 or re-coloring image

Memory 84 may also include image analysis software 90, as described below. Image analysis software 90 may include image processing software 88. In one embodiment, image processor 80 stores in memory 84 a processed image 78 of image 76 that has been processed with image processing software 88, as described below. FIGS. 6 and 6A illustrate exemplary processed images 78 of the photographic images of FIGS. 3 and 3A.

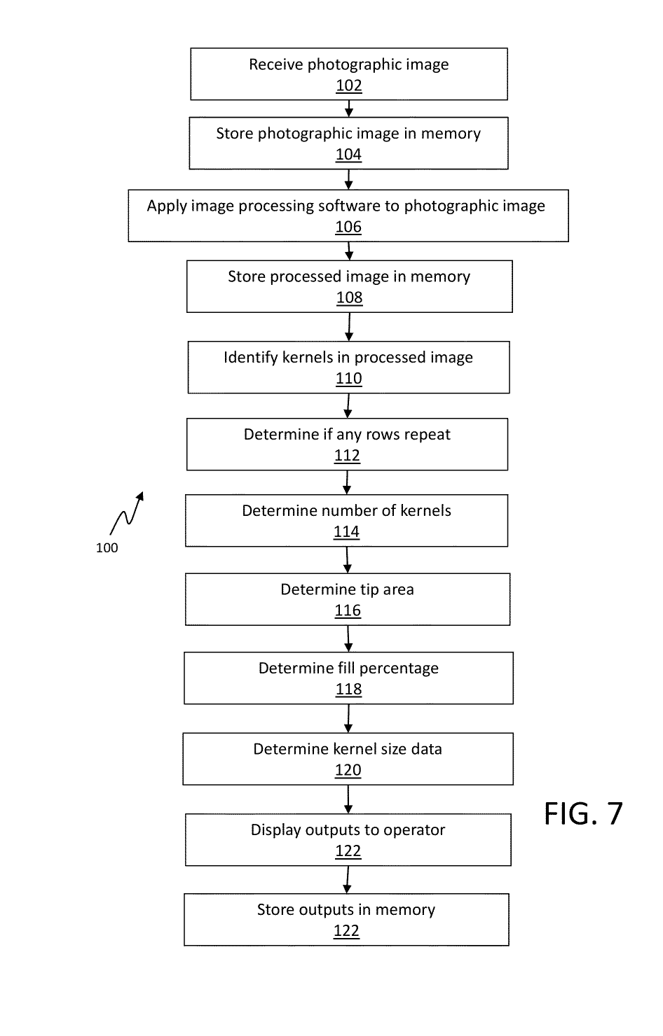

FIG. 7 illustrates an exemplary processing sequence 100 for the image processor 80 of FIG. 5. In block 102, a photographic image displaying at least a portion of a back region of the sample reflected in a reflected surface, such as image 76, is provided to image processor 80. In block 104, image processor 80 stores image 76 in memory 84. Image processing software routines from image processing software 88 are then applied to image 76. Exemplary routines include applying color filters, re-coloring an image, grayscaling an image, segmenting an image, thresholding an image, boundary detection, lightening an image, darkening an image, cropping an image, and other suitable routines for processing a digital image. In one exemplary embodiment, the resulting processed image, such as processed image 78 (FIG. 6) contains well-defined kernels 48 (two exemplary kernels are indicated), images of any exposed cob area 49 and non-sample background has been eliminated. In one embodiment, processed image 78 is the same as image 76.

In block 108, the processed image 78 is then stored in memory 84.

In blocks 110 to 120, image analysis software 90 is used to analyze processed image 78. In one exemplary embodiment, processing sequence 100 includes one or more of blocks 110 to 120. In another embodiment, processing sequence 100 does not include one or more of blocks 110 to 120. Which of blocks 110 to 120 are included depends on the outputs desired to be determined, such as the outputs in block 122, that outputs are displayed an operator on display 94 or the outputs in block 124 that are stored in memory 84.

In block 110, image analysis software 90 identifies kernels. In one exemplary embodiment, image analysis software 90 uses a pattern recognition routine to identify kernels in processed image 78. Other suitable means for identifying kernels 48 in processed image 78 may also be used.

In block 112, image analysis software 90 determines if rows repeat. In one exemplary embodiment, image analysis software 90 identifies repeated rows by kernel patterns or repeated individual kernel characteristics in the kernels identified in block 110. In one embodiment, the rows extend along a longitudinal extent of the cob.

In block 114, image analysis software 90 determines the number of kernels. In one embodiment, this comprises counting the kernels identified in block 110. In another embodiment, this involves counting the kernels identified in block 110 and subtracting the number of kernels in the repeated rows identified in block 112. In still another embodiment, this involves counting the kernels identified in block 110 and adding an estimate of kernels not visible in the photographic images.

In one exemplary embodiment, the number of kernels is determined by counting the number of kernels in one or more rows on the ear, determining the number of rows on the ear, and subtracting a number of kernels corresponding to the exposed cob area in processed image 78.

In block 116, image analysis software 90 identifies a tip area 98 in each of the reflected regions. In one embodiment, tip area 98 is defined as a predetermined percentage at the top of the sample 32. In another embodiment, tip area 98 is defined as the area above the lowest exposed cob area 49.

In block 118, image analysis software 90 determines fill percentages. An exemplary total fill percentage is determined by dividing the total area identified as kernels on the ear in block 110 by the total area of kernels and exposed cob in processed image 78. An exemplary tip fill percentage is determined by dividing the total area identified as kernels in the tip area 98 in block 116 by the total area of kernels and exposed cob in the tip area 98 in processed image 78.

In block 120, image analysis software 90 determines kernel sizes. In one exemplary embodiment, image analysis software 90 determines the average size of kernels on sample 32 by averaging the size of each kernel identified in block 110. In another exemplary embodiment, image analysis software 90 determines a size distribution of kernels on sample 32 by categorizing each kernel identified in block 110 based on kernel size.

In one exemplary embodiment, in block 122, outputs determined in blocks 112 to 120 are displayed for operator on display 94. In another exemplary embodiment, in block 124, outputs determined in blocks 112 to 120 are stored in memory 84. In still another exemplary embodiment, an operator provides additional data, such as but not limited to kernel weight, ears per stalk, and stalks per acre, and processing sequence determines the estimated yield. Exemplary yields include bushels per acre and tons per acre.

While this invention has been described as relative to exemplary designs, the present invention may be further modified within the spirit and scope of this disclosure. Further, this application is intended to cover such departures from the present disclosure as come within known or customary practice in the art to which this invention pertains.

1. An apparatus for determining the number of kernels on a sample cob comprising:
at least one reflective surface;
an imaging system positioned to capture an image of the sample cob, wherein the image includes a front region of the sample cob and a back region of the sample cob displayed in the at least one reflective surface; and
an image processor that receives the image of the sample cob from the imaging system, identifies the presence of kernels in the image of the sample cob, and determines the number of kernels on the sample cob based on the identified presence of kernels in the image of the sample cob.

2. The apparatus of claim 1, further comprising a second reflective surface, wherein the image includes a second back region of the sample cob displayed in the second reflective surface.

3. The apparatus of claim 1 wherein the image processor determines the number of kernels by counting the kernels identified in the image.

4. The apparatus of claim 1 wherein the image processor determines whether any identified kernels appear in both the front region and the back region of the image.

5. The apparatus of claim 1 further comprising a light source and a container having an interior, wherein the at least one reflective surface and the imaging system are positioned in the interior of the container.

6. The apparatus of claim 1 wherein the image processor further determines a fill percentage of at least a portion of the sample cob.

7. The apparatus of claim 1 wherein the image processor further determines a predicted yield of an area based on the determined number of kernels on the sample cob.

8. The apparatus of claim 1, wherein a first kernel displayed in the image in the front region of the image and is also displayed in the image in the back region of the image.

9. The apparatus of claim 1, wherein a longitudinal axis of the sample cob is oriented in a first direction in both the front region of the image and the back region of the image.

10. The apparatus of claim 9, wherein a first kernel displayed in the image in the front region of the image is also displayed in the image in the back region of the image.

11. The apparatus of claim 10, wherein the front region of the image is spaced apart from the back region of the image in the image.

12. The apparatus of claim 1, wherein the at least one reflective surface includes a first mirror positioned to display the back region shown in the image and a second mirror positioned to display a second back region shown in the image.

13. The apparatus of claim 12, wherein a longitudinal axis of the sample cob is oriented in a first direction in each of the front region of the image, the back region of the image, and the second back region of the image.

14. The apparatus of claim 13, wherein a first kernel displayed in the image in the front region of the image is also displayed in the image in the back region of the image and a second kernel displayed in the image in the front region of the image is also displayed in the image in the second back region of the image.

15. The apparatus of claim 14, wherein the front region of the image is spaced apart from the back region of the image in the image, the front region of the image is spaced apart from the second back region of the image, and the back region of the image is spaced apart from the second back region of the image.

16. The apparatus of claim 13, wherein a first kernel displayed in the image in the front region of the image is also displayed in the image in the back region of the image, a second kernel displayed in the image in the front region of the image is also displayed in the image in the second back region of the image, and a third kernel displayed in the image in the back region of the image is also displayed in the image in the second back region of the image.

17. The apparatus of claim 16, wherein the front region of the image is spaced apart from the back region of the image in the image, the front region of the image is spaced apart from the second back region of the image, and the back region of the image is spaced apart from the second back region of the image.

18. A method for determining the number of kernels on a sample cob having a circumference, the method comprising:
positioning the sample cob between an imaging system and at least one reflective surface the sample cob having a front region oriented towards the imaging system and a back region oriented away from the imaging system;
capturing an image of the sample cob, the image including greater than 180° of a circumference of the cob
identifying a presence of kernels in the image of the sample cob; and
determining the number of kernels on the sample cob based on the identified presence of kernels in the image of the sample cob.

19. The method of claim 18, wherein the determining step is further based on an identified presence of an exposed area of the sample cob.

20. The method of claim 18, wherein the image includes the front region of the cob and the back region of the cob.

21. The method of claim 18, wherein the back region of the cob is visible in the image through a reflection from the at least one reflective surface.

22. The method of claim 21, wherein the back region of the cob in the image is spaced apart from the front region of the cob in the image.
